(19) United States
(12) Patent Application Publication
(10) Pub. No.: US 2023/0178281 A1
(43) Pub. Date: Jun. 8, 2023

(54) COIL COMPONENT

(71) Applicant: SAMSUNG ELECTRO-MECHANICS CO., LTD., Suwon-si (KR)

(72) Inventors: Sung Nam CHO, Suwon-si (KR); Ki Young YOO, Suwon-si (KR); Ji Soo YOU, Suwon-si (KR)

(73) Assignee: SAMSUNG ELECTRO-MECHANICS CO., LTD., Suwon-si (KR)

(21) Appl. No.: 17/981,850

(22) Filed: Nov. 7, 2022

(30) Foreign Application Priority Data
Dec. 7, 2021 (KR) 10-2021-0174036

(51) Int. Cl. H01F 17/00; H01F 5/04; H01F 27/28

(52) U.S. Cl. CPC H01F 17/0013; H01F 5/04; H01F 27/2852; H01F 2017/002

(57) ABSTRACT

A coil component includes: a body; a substrate disposed in the body, and having a first surface and a second surface facing each other; a coil unit including first and second coil patterns disposed on the first surface and the second surface of the substrate, respectively, first and second lead-out portions extending to surfaces of the body, a first connection portion disposed between the first coil pattern and the first lead-out portion, and a second connection portion disposed between the second coil pattern and the second lead-out portion; and first and second external electrodes disposed to be spaced apart from each other on the body and connected to the first and second lead-out portions, respectively. Each of the first and second connection portions includes one connection pattern and at least one separation pattern. The connection pattern has a smaller line width than a respective one of the lead-out portions.

### CROSS-REFERENCE TO RELATED APPLICATION(S)

This application claims the benefit of priority to Korean Patent Application No. 10-2021-0174036 filed on Dec. 7, 2021 in the Korean Intellectual Property Office, the disclosure of which is incorporated herein by reference in its entirety.

### TECHNICAL FIELD

The present disclosure relates to a coil component.

### BACKGROUND

An inductor, one of coil components, is a typical passive electronic component used in an electronic device together with a resistor and a capacitor.

As electronic devices are increasingly improved in performance while their sizes become smaller, the number of electronic components used in the electronic devices has increased, and the sizes of the electronic components have decreased.

Meanwhile, in order to implement a thin film type power inductor having a small size to have a desired Rdc characteristic, a thickness of copper plating is adjusted. However, this method has a problem that it is difficult to finely adjust Rdc.

### SUMMARY

An aspect of the present disclosure may provide a coil component having an Rdc value that can be finely adjusted in a process of manufacturing the coil component to implement an almost desired Rdc characteristic.

According to an aspect of the present disclosure, a coil component may include: a body; a substrate disposed in the body, and having a first surface and a second surface facing each other; a coil unit including first and second coil patterns disposed on the first surface and the second surface of the substrate, respectively, first and second lead-out portions extending to surfaces of the body, a first connection portion disposed between the first coil pattern and the first lead-out portion, and a second connection portion disposed between the second coil pattern and the second lead-out portion; and first and second external electrodes disposed to be spaced apart from each other on the body and connected to the first and second lead-out portions, respectively. Each of the first and second connection portions includes one connection pattern and at least one separation pattern, in which the connection pattern has a smaller line width than a respective one of the first and second lead-out portions.

According to an aspect of the present disclosure, a coil component may include: a body; a substrate disposed in the body; a coil unit including a coil pattern disposed on the substrate, a lead-out portion, and a connection portion disposed between the coil pattern and the lead-out portion; and an external electrode disposed on the body and connected to the lead-out portion. The connection portion includes a connection pattern connecting an end portion of the coil pattern to the lead-out portion and at least one separation pattern spaced apart from the connection pattern. The at least one separation pattern includes at least one protrusion that protrudes from an inner surface of the lead-out portion and/or an outer surface of the end portion of the coil pattern.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a coil component according to a first exemplary embodiment in the present disclosure;

FIG. 2 is a bottom perspective view of FIG. 1;

FIG. 3 is a plan view of FIG. 1 provided together with an enlarged view of a region around a lead-out portion;

FIG. 4 is a bottom view of FIG. 1 provided together with an enlarged view of a region around a lead-out portion;

FIG. 5 is a cross-sectional view of FIG. 1 taken along line I-I′;

FIG. 6 is a cross-sectional view of FIG. 1 taken along line II-II′;

FIG. 7 is a plan view corresponding FIG. 3 before separation patterns are removed from a connection portion;

FIG. 8 is a view related to a second exemplary embodiment, in which the connection portion is disposed in a different manner, and corresponding to FIG. 3;

FIG. 9 is a view related to a third exemplary embodiment, in which the connection portion is disposed in a different manner, and corresponding to FIG. 3; and

FIG. 10 is a schematic perspective view illustrating a coil component according to a fourth exemplary embodiment in the present disclosure.

### DETAILED DESCRIPTION

Hereinafter, exemplary embodiments in the present disclosure will now be described in detail with reference to the accompanying drawings.

In the drawings, an L direction may be defined as a first direction or a length direction, a W direction may be defined as a second direction or a width direction, and a T direction may be defined as a third direction or a thickness direction.

Various kinds of electronic components may be used in electronic devices, and various kinds of coil components may be appropriately used between these electronic components to remove noise or for other purposes.

That is, in the electronic devices, the coil components may be used as power inductors, high frequency (HF) inductors, general beads, high frequency (GHz) beads, common mode filters, and the like.

### First Exemplary Embodiment

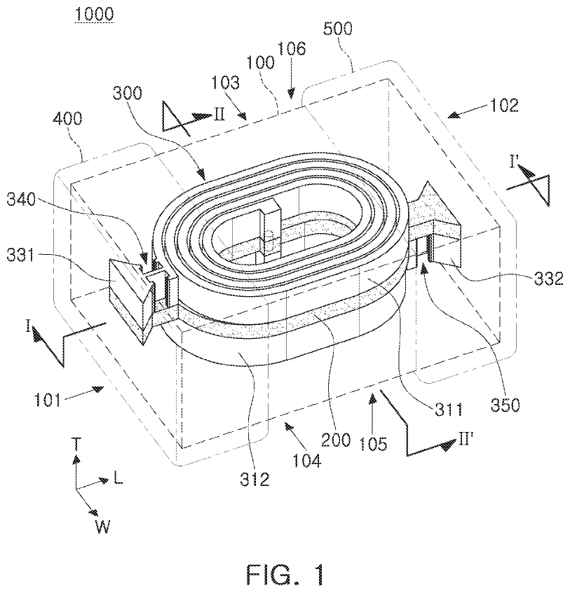

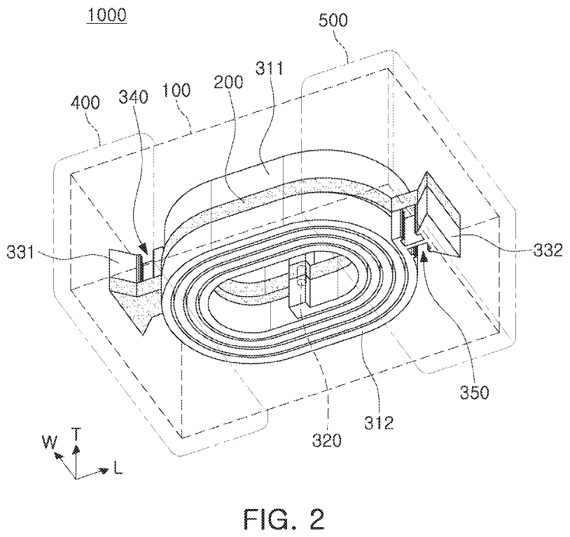

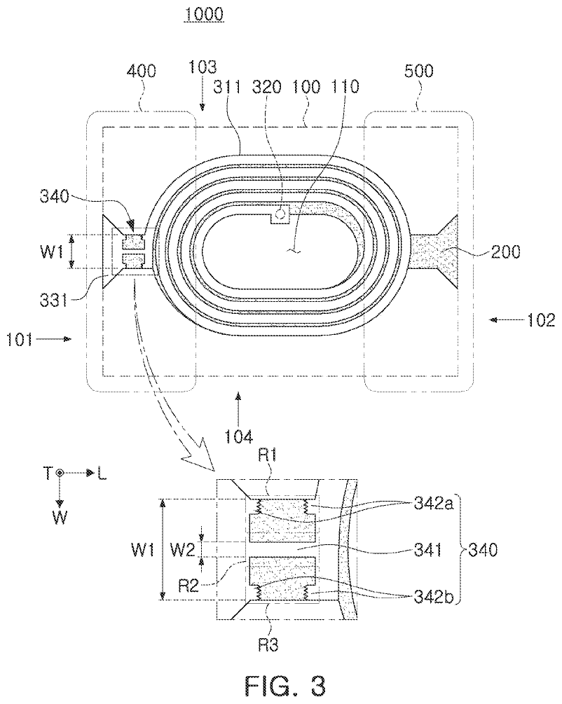

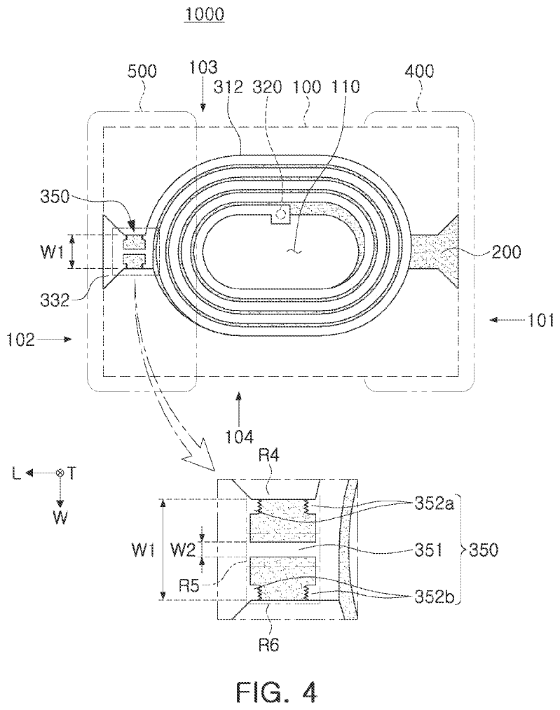

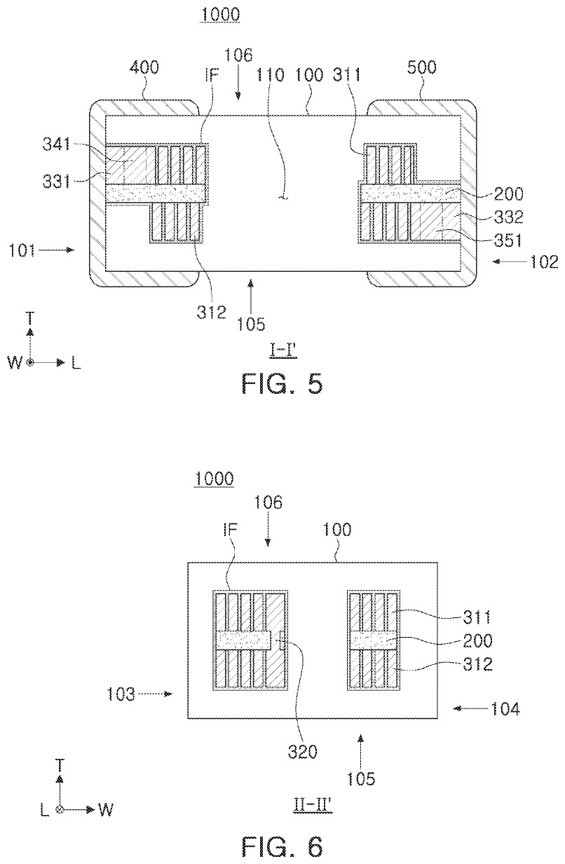

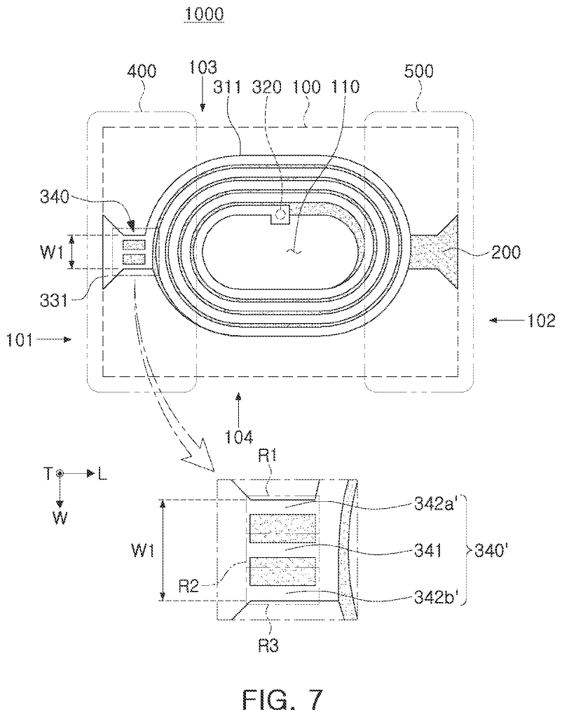

FIG. 1 is a schematic perspective view illustrating a coil component 1000 according to a first exemplary embodiment in the present disclosure. FIG. 2 is a bottom perspective view of FIG. 1. FIG. 3 is a plan view of FIG. 1 provided together with an enlarged view of a region around a lead-out portion. FIG. 4 is a bottom view of FIG. 1 provided together with an enlarged view of a region around a lead-out portion. FIG. 5 is a cross-sectional view of FIG. 1 taken along line I-I′. FIG. 6 is a cross-sectional view of FIG. 1 taken along line FIG. 7 is a plan view corresponding FIG. 3 before separation patterns are removed from a connection portion.

Meanwhile, in order to more clearly illustrate connections between elemental constituents, an external insulating layer, which is applied onto a body 100 of the present exemplary embodiment, is omitted in the drawings.

Referring to FIGS. 1 through 6, the coil component 1000 according to the first exemplary embodiment in the present disclosure may include a body 100, a substrate 200, a coil unit 300, and first and second external electrodes 400 and 500, and may further include an insulating film IF.

The body 100 may form an appearance of the coil component 1000 according to the present exemplary embodiment, and the coil unit 300 and the substrate 200 may be disposed in the body 100.

The body 100 may generally have a hexahedral shape.

Based on the directions of FIGS. 1 through 6, the body 100 may have a first surface 101 and a second surface 102 facing each other in the length direction L, a third surface 103 and a fourth surface 104 facing each other in the width direction W, and a fifth surface 105 and a sixth surface 106 facing each other in the thickness direction T. The first to fourth surfaces 101 to 104 of the body 100 may be wall surfaces of the body 100 that connect the fifth surface 105 and the sixth surface 106 of the body 100 to each other. Hereinafter, opposite end surfaces (one end surface and the other end surface) of the body 100 may refer to the first surface 101 and the second surface 102 of the body 100, respectively, opposite side surfaces (one side surface and the other side surface) of the body 100 may refer to the third surface 103 and the fourth surface 104 of the body 100, respectively, and one surface and the other surface of the body 100 may refer to the fifth surface 105 and the sixth surface 106 of the body 100, respectively.

The body 100 may be formed so that the coil component 1000 according to the present exemplary embodiment in which the external electrodes 400 and 500 to be described below are formed, for example, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.5 mm, or has a length of 0.8 mm, a width of 0.4 mm, and a thickness of 0.65 mm, but is not limited thereto. Meanwhile, the above-described numerical values are merely design values in which process errors and the like are not reflected. Thus, numerical values including process errors in an allowable range may be considered to fall within the scope of the present disclosure.

Based on a photograph of a cross section of the coil component 1000 in the length direction L-thickness direction T taken at a central portion thereof in the width direction W using an optical microscope or a scanning electron microscope (SEM), the above-mentioned length of the coil component 1000 may refer to a maximum value among dimensions of a plurality of line segments parallel to the length direction L, each connecting two outermost boundary lines facing each other in the length direction L of the coil component 1000 illustrated in the photograph of the cross section thereof. Alternatively, the length of the coil component 1000 may refer to a minimum value among dimensions of a plurality of line segments parallel to the length direction L, each connecting two outermost boundary lines facing each other in the length direction L of the coil component 1000 illustrated in the photograph of the cross section thereof. Alternatively, the length of the coil component 1000 may refer to an arithmetic mean value of at least three among dimensions of a plurality of line segments parallel to the length direction L, each connecting two outermost boundary lines facing each other in the length direction L of the coil component 1000 illustrated in the photograph of the cross section thereof. Here, the plurality of line segments parallel to the length direction L may be equally spaced from each other in the thickness direction T, but the scope of the present disclosure is not limited thereto.

Based on a photograph of a cross section of the coil component 1000 in the length direction L-thickness direction T taken at a central portion thereof in the width direction W using an optical microscope or a scanning electron microscope (SEM), the above-mentioned thickness of the coil component 1000 may refer to a maximum value among dimensions of a plurality of line segments parallel to the thickness direction T, each connecting two outermost boundary lines facing each other in the thickness direction T of the coil component 1000 illustrated in the photograph of the cross section thereof. Alternatively, the thickness of the coil component 1000 may refer to a minimum value among dimensions of a plurality of line segments parallel to the thickness direction T, each connecting two outermost boundary lines facing each other in the thickness direction T of the coil component 1000 illustrated in the photograph of the cross section thereof. Alternatively, the thickness of the coil component 1000 may refer to an arithmetic mean value of at least three among dimensions of a plurality of line segments parallel to the thickness direction T, each connecting two outermost boundary lines facing each other in the thickness direction T of the coil component 1000 illustrated in the photograph of the cross section thereof. Here, the plurality of line segments parallel to the thickness direction T may be equally spaced from each other in the length direction L, but the scope of the present disclosure is not limited thereto.

Based on a photograph of a cross section of the coil component 1000 in the length direction L-width direction W taken at a central portion thereof in the thickness direction T using an optical microscope or a scanning electron microscope (SEM), the above-mentioned width of the coil component 1000 may refer to a maximum value among dimensions of a plurality of line segments parallel to the width direction W, each connecting two outermost boundary lines facing each other in the width direction W of the coil component 1000 illustrated in the photograph of the cross section thereof. Alternatively, the width of the coil component 1000 may refer to a minimum value among dimensions of a plurality of line segments parallel to the width direction W, each connecting two outermost boundary lines facing each other in the width direction W of the coil component 1000 illustrated in the photograph of the cross section thereof. Alternatively, the width of the coil component 1000 may refer to an arithmetic mean value of at least three among dimensions of a plurality of line segments parallel to the width direction W, each connecting two outermost boundary lines facing each other in the width direction W of the coil component 1000 illustrated in the photograph of the cross section thereof. Here, the plurality of line segments parallel to the width direction W may be equally spaced from each other in the length direction L, but the scope of the present disclosure is not limited thereto.

Alternatively, each of the length, width, and thickness of the coil component 1000 may be measured by a micrometer measurement method. In the micrometer measurement method, each of the length, width, and thickness of the coil component 1000 may be measured by setting a zero point using a micrometer having gage repeatability and reproducibility (R&R), inserting the coil component 1000 according to the present exemplary embodiment between tips of the micrometer, and turning a measurement lever of the micrometer. Meanwhile, concerning the measurement of the length of the coil component 1000 by the micrometer measurement method, the length of the coil component 1000 may refer to a value measured once, or may refer to an arithmetic mean of values measured multiple times. The same may also be applied to the width and the thickness of the coil component 1000.

The body 100 may include an insulating resin and a magnetic material. Specifically, the body 100 may be formed by stacking one or more magnetic composite sheets in which the magnetic material is dispersed in the insulating resin. The magnetic material may be ferrite or metal magnetic powder.

The ferrite may be, for example, one or more of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, and Li-based ferrite.

The metal magnetic powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be one or more of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, and Fe—Cr—Al-based alloy powder.

The metal magnetic powder may be amorphous or crystalline. For example, the metal magnetic powder may be Fe—Si—B—Cr-based amorphous alloy powder, but is not necessarily limited thereto.

Each of the ferrite and the metal magnetic powder may have an average particle diameter of about 0.1 μm to 30 μm, but is not limited thereto.

The body 100 may include two or more types of magnetic materials dispersed in the resin. Here, the different types of magnetic materials mean that the magnetic materials dispersed in the resin are distinguished from each other in terms of any one of average particle diameter, composition, crystallinity, and shape.

Meanwhile, although the body 100 will be described hereinbelow on the premise that the magnetic material is magnetic metal powder, the scope of the present disclosure is not limited to the body 100 having a structure in which the magnetic metal powder is dispersed in the insulating resin.

The insulating resin may include an epoxy, a polyimide, a liquid crystal polymer (LCP), or a mixture thereof, but is not limited thereto.

The body 100 may include a core 110 penetrating through the substrate 200 and the coil unit 300 to be described below. The core 110 may be formed by filling a through hole 111h penetrating through the center of the coil unit 300 and the center of the substrate 200 with the magnetic composite sheets including the magnetic material, but is not limited thereto.

The substrate 200 may be disposed inside the body 100. The substrate 200 may be configured to support the coil unit 300 to be described below.

The substrate 200 may be formed of an insulating material including a thermosetting insulating resin such as an epoxy resin, a thermoplastic insulating resin such as a polyimide resin, or a photosensitive insulating resin, or may be formed of an insulating material in which a reinforcing material such as a glass fiber or an inorganic filler is impregnated in such an insulating resin. As an example, the substrate 200 may be formed of an insulating material such as prepreg, an Ajinomoto build-up film (ABF), FR-4, a bismaleimide triazine (BT) resin, or a photoimagable dielectric (PID), but is not limited thereto.

The inorganic filler may be at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the substrate 200 is formed of an insulating material including a reinforcing material, the substrate 200 may provide more excellent rigidity. When the substrate 200 is formed of an insulating material including no glass fiber, this may be advantageous in decreasing a thickness of the coil component 1000 according to the present exemplary embodiment. In addition, based on the body 100 of the same size, the substrate 200 formed of an insulating material including no glass fiber makes it possible to increase a volume occupied by the coil unit 300 and/or the magnetic metal powder, thereby improving component characteristics. When the substrate 200 is formed of an insulating material including a photosensitive insulating resin, the number of processes for forming the coil unit 300 may decrease, which is advantageous in decreasing a production cost and in forming a fine via 320.

The substrate 200 may have a thickness of, for example, 10 μm or more and 50 μm or less, but is not limited thereto.

The coil unit 300 may be disposed inside the body 100 to exhibit characteristics of the coil component 1000. For example, when the coil component 1000 according to the present exemplary embodiment is utilized as a power inductor, the coil unit 300 may serve to stabilize power of an electronic device by storing an electric field as a magnetic field and maintaining an output voltage.

The coil component 1000 according to the present exemplary embodiment may include a coil unit 300 supported by the substrate 200 inside the body 100.

Referring to FIGS. 1 through 6, the coil unit 300 may include first and second coil patterns 311 and 312, a via 320, first and second lead-out portions 331 and 332, and first and second connection portions 340 and 350.

Specifically, based on the directions of FIGS. 1 through 6, the first coil pattern 311, the first lead-out portion 331, and the first connection portion 340 may be disposed on a first surface of the substrate 200 facing the sixth surface 106 of the body 100, and the second coil pattern 312, the second lead-out portion 332, and the second connection portion 350 may be disposed on a second surface of the substrate 200 facing the fifth surface 105 of the body 100.

Referring to FIGS. 1, 2, and 6, the via 320 may penetrate through the substrate 200 to be connected in contact with an inner end of each of the first coil pattern 311 and the second coil pattern 312. At this time, in order to increase reliability in connection between the via 320 and the inner end of each of the first and second coil patterns 311 and 312, via pads may be formed to increase areas of the coil patterns connected to the via 320.

The first lead-out portion 331 may be connected to the first coil pattern 311 through the first connection portion 340, and extend to the first surface 101 of the body 100, and may be connected to the first external electrode 400 to be described below.

The second lead-out portion 332 may be connected to the second coil pattern 312 through the second connection portion 350, and extend to the second surface 102 of the body 100, and may be connected to the second external electrode 500 to be described below.

That is, an input from the first external electrode 400 may be output through the second external electrode 500 after sequentially passing through the first lead-out portion 331, the first connection portion 340, the first coil pattern 311, the via 320, the second coil pattern 312, the second connection portion 350, and the second lead-out portion 332.

By doing so, the coil unit 300 may function as a single coil as a whole between the first and second external electrodes 400 and 500.

Referring to FIGS. 3 and 4, each of the first coil pattern 311 and the second coil pattern 312 may have a planar spiral shape in which at least one turn is formed around the core 110. The first coil pattern 311 may form at least one turn around the core 110 on the first surface of the substrate 200. The second coil pattern 312 may form at least one turn around the core 110 on the second surface of the substrate 200.

Referring to FIGS. 3 through 5, the first and second lead-out portions 331 and 332 may extend to the first and second surfaces 101 and 102 of the body 100, respectively. Specifically, the first lead-out portion 331 may extend to the first surface 101 of the body 100, and the second lead-out portion 332 may extend to the second surface 102 of the body 100.

Referring to FIGS. 1 through 3, the first and second lead-out portions 331 and 332 may have a cross-sectional area that gradually decreases in an inward direction of the body 100 from the first and second surfaces 101 and 102 of the body 100, respectively, in an image of an L-T cross section thereof.

Referring to FIG. 3, the first and second lead-out portions 331 and 332 may have a width that gradually decreases in the inward direction of the body 100 from the first and second surfaces 101 and 102 of the body 100, respectively, in an image of an L-T cross section thereof. Here, based on a photograph of a cross section of each of the coil patterns 311 and 312 in the length direction L-width direction W taken at a central portion thereof in the thickness direction T using an optical microscope or a scanning electron microscope (SEM), the width of each of the first and second lead-out portions 331 and 332 may refer to an arithmetic mean value of at least three among dimensions of a plurality of line segments parallel to the width direction W, each connecting two outermost boundary lines facing each other in the width direction W of each of the first and second lead-out portions 331 and 332 illustrated in the photograph of the cross section thereof. Here, the plurality of line segments parallel to the width direction W may be equally spaced from each other in the length direction L, but the scope of the present disclosure is not limited thereto. Other measurement methods and/or tools appreciated by one of ordinary skill in the art, even if not described in the present disclosure, may also be used.

The first and second connection portions 340 and 350, which are configured to connect the coil patterns 311 and 312 and the lead-out portions 331 and 332 to each other, may be disposed between the first and second coil patterns 311 and 312 and the first and second lead-out portions 331 and 332, respectively.

Referring to FIG. 3, the first connection portion 340 may have first to third regions R1 to R3 sequentially in a direction in which the outermost turn of the first coil pattern 311 is wound from an inner side to an outer side thereof.

Referring to FIG. 4, the second connection portion 350 may have fourth to sixth regions R4 to R6 sequentially in a direction in which the outermost turn of the second coil pattern 312 is wound from an inner side to an outer side thereof.

The first and second connection portions 340 and 350 may include connection patterns 341 and 351 and separation patterns 342a and 342b and 352a and 352b, respectively.

Referring to FIG. 3, the first connection portion 340 of the coil component 1000 according to the present exemplary embodiment may include two separation patterns 342a and 342b and a first connection pattern 341 disposed between two separation patterns 342a and 342b. That is, the separation patterns 342a and 342b may be disposed in the first and third regions R1 and R3, and the first connection pattern 341 may be disposed in the second region R2. According to one exemplary embodiment, at least one of the two separation patterns 342a and 342b may have at least one protrusion that protrudes from an inner surface of the first lead-out portion 331 and/or an outer surface of an end portion of the first coil pattern 311.

Among the elemental constituents of the connection portions 340 and 350, the first and second connection patterns 341 and 351 may function to directly connect the coil patterns 311 and 312 to the lead-out portions 331 and 332.

In the coil component 1000 according to the present exemplary embodiment, in a state where the coil unit 300 is formed on the substrate 200 through plating before the body 100 is formed by filling a magnetic material, the separation patterns 342a and 342b and 352a and 352b may be formed by measuring a current through electrical inspection and removing some of the conductors of the connection portions 340 and 350 to accurately implement a desired Rdc value.

FIG. 7 is a plan view corresponding FIG. 3 before the separation pattern 342a and 342b and 352a and 352b are cut out from the connection portion. Referring to FIG. 7, the first connection portion 340 may include a first connection pattern 341 and separation patterns 342a′ and 342b′ before being cut out. The separation patterns 342a′ and 342b′ before being cut out may be formed of conductors to connect the first coil pattern 311 and the first lead-out portion 331 to each other, like the first connection pattern 341.

Thereafter, as a result of measuring an Rdc value through electrical inspection, when the measured value is within a reference range for the desired Rdc value, the separation patterns 342a′ and 342b′ before being cut out on both sides of the first connection pattern 341, that is, the conductors in the first and third regions R1 and R3, may be cut out from the first connection portion.

When the measured value is above the reference range for the desired Rdc value, the conductors in the second and third regions R2 and R3 may be cut out from the first connection portion to decrease a length of the outermost turn of the first coil pattern 311, thereby decreasing the Rdc value.

When the measured value is below the reference range for the desired Rdc value, the conductors in the first and second regions R1 and R2 may be cut out from the first connection portion to increase a length of the outermost turn of the first coil pattern 311, thereby increasing the Rdc value.

The same may be identically applied to the second connection portion 350 disposed on the second surface of the substrate 200. Therefore, like the first connection portion 340, the second connection portion 350 may be implemented with three options of paths based on the disposition of the connection pattern 351. As a result, various Rdc values can be implemented by finely adjusting Rdc based on how the first and second connection portions 340 and 350 are combined together.

The separation patterns 342a and 342b and 352a and 352b may be formed by cutting out the connection portions using laser, and thus, each of the separation patterns 342a, 342b, 352a, and 352b may include a pair of cut-out surfaces facing each other, the cut-out surfaces having a different surface roughness from other surfaces of each of the separation patterns 342a, 342b, 352a, and 352b. Depending on the power and irradiation angle of the laser, the cut-out surfaces of the separation patterns 342a, 342b, 352a, and 352b may have a larger or smaller surface roughness than the other surfaces of the separation patterns 342a, 342b, 352a, and 352b. Particularly, the cut-out surfaces of the separation patterns 342a, 342b, 352a, and 352b, which are melted by the laser, may have a smaller surface roughness than the other surfaces of the separation patterns 342a, 342b, 352a, and 352b, but are not limited thereto.

Referring to FIG. 3, the first connection pattern 341 may be branched from an end portion of the outermost turn of the first coil pattern 311 to be connected to the first lead-out portion 331. In the coil component 1000 according to the present exemplary embodiment, the first connection pattern 341 may be disposed in the second region R2, and the separation patterns 342a and 342b may be disposed in the first and third regions R1 and R3, respectively.

Referring to FIG. 4, the second connection pattern 351 may be branched from an end portion of the outermost turn of the second coil pattern 312 to be connected to the second lead-out portion 332. In the coil component 1000 according to the present exemplary embodiment, the second connection pattern 351 may be disposed in the fifth region R5, and the separation patterns 352a and 352b may be disposed in the fourth and six regions R4 and R6, respectively.

Each of the first and second connection patterns 341 and 351 may be formed in a strip shape in the length direction L of the coil component 1000 according to the present exemplary embodiment.

Referring to FIGS. 3 and 4, each of the first and second connection patterns 341 and 351 may have a predetermined line width W2, and a ratio W2/W1 of the line width W2 of each of the connection patterns 341 and 351 to an innermost line width W1 of each of the lead-out portions 331 and 332 may be 0.1 or more and 0.3 or less, but is not limited thereto.

Table 1 shows experimental data obtained by changing a ratio W2/W1 of the line width W2 of each of the connection patterns 341 and 351 to the innermost line width W1 of each of the lead-out portions 331 and 332 to check whether the number of paths changed, whether a defect occurred, etc.

TABLE 1

| | | | Whether | | | |
|---|---|---|---|---|---|---|
| | The | Plating | electrical | Whether | | |
| W2/ | number | differ- | inspection | coil is | Dicing | Dicing |
| W1 | of paths | ence | is available | deformed | burr | chipping |
| 0.05 | ◯ | OK | Not available | NG | OK | OK |
| 0.1 | ◯ | OK | Available | OK | OK | OK |
| 0.2 | ◯ | OK | Available | OK | OK | OK |
| 0.3 | ◯ | OK | Available | OK | OK | OK |
| 0.4 | X | NG | Not available | OK | NG | NG |
| 0.5 | X | NG | Not available | OK | NG | NG |

Referring to Table 1, the number of paths refers to the number of paths allowing current to flow through the connection patterns 341 and 351, and the plating difference refers to a difference in plating thickness between the coil patterns 311 and 312 and the connection patterns 341 and 351.

Referring to Table 1, when the ratio W2/W1 of the line width W2 of each of the connection patterns 341 and 351 to the innermost line width W1 of each of the lead-out portions 331 and 332 is less than 0.1, it may not be possible to perform electrical inspection for measuring Rdc, and the connection patterns 341 and 351 may be deformed in shape.

Meanwhile, in order to finely adjust an Rdc value, it is preferable that three or more paths are formed between each of the coil patterns 311 and 312 and each of the lead-out portions 331 and 332. However, when the ratio W2/W1 of the line width W2 of each of the connection patterns 341 and 351 to the innermost line width W1 of each of the lead-out portions 331 and 332 is more than 0.3, it may be difficult to form three or more paths.

In addition, when the ratio W2/W1 of the line width W2 of each of the connection patterns 341 and 351 to the innermost line width W1 of each of the lead-out portions 331 and 332 is more than 0.3, a difference in plating thickness between the coil patterns 311 and 312 and the connection patterns 341 and 351 may be severe, and this defect may also cause an increase in dicing burring or dicing chipping defect rate.

Therefore, in order to solve the above-mentioned problems, the ratio W2/W1 of the line width W2 of each of the connection patterns 341 and 351 to the innermost line width W1 of each of the lead-out portions 331 and 332 may preferably be 0.1 or more and 0.3 or less, but is not limited thereto.

At least one of the first and second coil patterns 311 and 312, the via 320, the first and second lead-out portions 331 and 332, and the first and second connection portions 340 and 350 may include at least one conductive layer.

For example, when the first coil pattern 311, the via 320, the first lead-out portion 331, and the first connection portion 340 are formed on the first surface of the substrate 200 by plating, each of the first coil pattern 311, the via 320, the first lead-out portion 331, and the first connection portion 340 may include a seed layer and an electrolytic plating layer. Here, the electrolytic plating layer may have a single-layer structure or have a multi-layer structure. The electrolytic plating layer having the multi-layer structure may be formed in a conformal film structure in which one electrolytic plating layer is formed along a surface of another electrolytic plating layer, or may be formed by stacking one electrolytic plating layer on only one surface of another electrolytic plating layer. The seed layer may be formed by an electroless plating method, a vapor deposition method such as sputtering, or the like. The seed layers of the first coil pattern 311, the via 320, the first lead-out portion 331, and the first connection portion 340 may be integrally formed, such that no boundaries are formed therebetween, but are not limited thereto. The electrolytic plating layers of the first coil pattern 311, the via 320, the first lead-out portion 331, and the first connection portion 340 may be integrally formed, such that no boundaries are formed therebetween, but are not limited thereto.

Each of the first coil pattern 311, the via 320, the first lead-out portion 331, and the first connection portion 340 may be formed of a conductive material such as copper (Cu), aluminum (Al), silver (Ag), tin (Sn), gold (Au), nickel (Ni), lead (Pb), titanium (Ti), chromium (Cr), or an alloy thereof, but is not limited thereto.

The insulating film IF may be disposed between the coil unit 300 and the body 100 and between the substrate 200 and the body 100.

Referring to FIGS. 5 and 6, the insulating film IF may be formed along the surfaces of the substrate 200 on which the first and second coil patterns 311 and 312, the first and second connection portions 340 and 350, and the first and second lead-out portions 331 and 332 are formed, but is not limited thereto.

The insulating film IF may be filled between adjacent turns of each of the first and second coil patterns 311 and 312, between the first lead-out portion 331 and the first coil pattern 311, and between the second lead-out portion 332 and the second coil pattern 312 for insulation between coil turns.

The insulating film IF may be provided to insulate the coil unit 300 and the body 100 from each other, and may include a known insulating material such as parylene, but is not limited thereto. As another example, the insulating film IF may include an insulating material such as an epoxy resin rather than parylene. The insulating film IF may be formed by a vapor deposition method, but is not limited thereto. As another example, the insulating film IF may be formed by stacking insulation films for forming the insulating film IF on both surfaces of the substrate 200 on which the coil unit 300 is formed and then curing the insulation films, or may be formed by applying an insulation paste for forming the insulating film IF onto both surfaces of the substrate 200 on which the coil unit 300 is formed and then curing the insulation paste. Meanwhile, the insulating film IF may be omitted in the present exemplary embodiment for the above-described reason. That is, if the body 100 has a sufficient electrical resistance at an operating current and voltage designed for the coil component 1000 according to the present exemplary embodiment, the insulating film IF may be omitted in the present exemplary embodiment.

The external electrodes 400 and 500 may be disposed to be spaced apart from each other on the body 100, while each being connected to the coil unit 300. Specifically, the first external electrode 400 may be disposed on the first surface 101 of the body 100 to be connected in contact with the first lead-out portion 331 that extends to the first surface 101 of the body 100, and the second external electrode 500 may be disposed on the second surface 102 of the body 100 to be connected in contact with the second lead-out portion 332 that extends to the second surface 102 of the body 100.

The first external electrode 400 may be disposed on the first surface 101 of the body 100 and extend to at least some of the third to sixth surfaces 103 to 106 of the body 100. The second external electrode 500 may be disposed on the second surface 102 of the body 100 and extend to at least some of the third to sixth surfaces 103 to 106 of the body 100.

Meanwhile, each of the first and second external electrodes 400 and 500 disposed on the first and second surfaces 101 and 102 of the body 100, respectively, may extend only to the fifth surface 105 of the body 100.

In this case, the first external electrode 400 may include a first pad portion disposed on the fifth surface 105 of the body 100, and a first extension portion disposed on the first surface 101 of the body 100 to connect the first lead-out portion 331 and the first pad portion to each other.

In addition, the second external electrode 500 may include a second pad portion disposed to be spaced apart from the first pad portion on the fifth surface 105 of the body 100, and a second extension portion disposed on the second surface 102 of the body 100 to connect the second lead-out portion 332 and the second pad portion to each other.

The pad portion and the extension portion may be formed together in the same process to be integrally formed without any boundaries formed therebetween, but the scope of the present disclosure is not limited thereto.

The external electrodes 400 and 500 may be formed by a vapor deposition method such as sputtering and/or a plating method, but are not limited thereto.

The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), or an alloy thereof, but is not limited thereto.

Each of the external electrodes 400 and 500 may be formed in a single-layer structure or in a multi-layer structure. For example, each of the external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but the scope of the present disclosure is not limited thereto. The first conductive layer may be a plating layer, or a conductive resin layer formed by applying and curing a conductive resin including a conductive powder containing at least one of copper (Cu) and silver (Ag) and a resin. The second and third conductive layers may be plating layers, but the scope of the present disclosure is not limited thereto.

The coil component 1000 according to the present exemplary embodiment may further include an external insulating layer disposed on the third to sixth surfaces 103 to 106 of the body 100. The external insulating layer may be disposed in regions other than the regions where the external electrodes 400 and 500 are disposed.

At least partial portions of the external insulating layer disposed on the third to sixth surfaces 103 to 106 of the body 100 may be formed in the same process to be integrally formed without any boundaries formed therebetween, but the scope of the present disclosure is not limited thereto.

The external insulating layer may be formed by forming an insulating material for forming the external insulating layer by a printing method, a vapor deposition method, a spray application method, a film lamination method, or the like, but is not limited thereto.

The external insulating layer may include a thermoplastic resin such as polystyrene, vinyl acetate, polyester, polyethylene, polypropylene, polyamide, rubber, or acryl, a thermosetting resin such as phenol, epoxy, urethane, melamine, or alkyd, a photosensitive resin, parylene, SiOₓ, or SiNₓ. The external insulating layer may further include an insulating filler such as an inorganic filler, but is not limited thereto.

### Second and Third Exemplary Embodiments

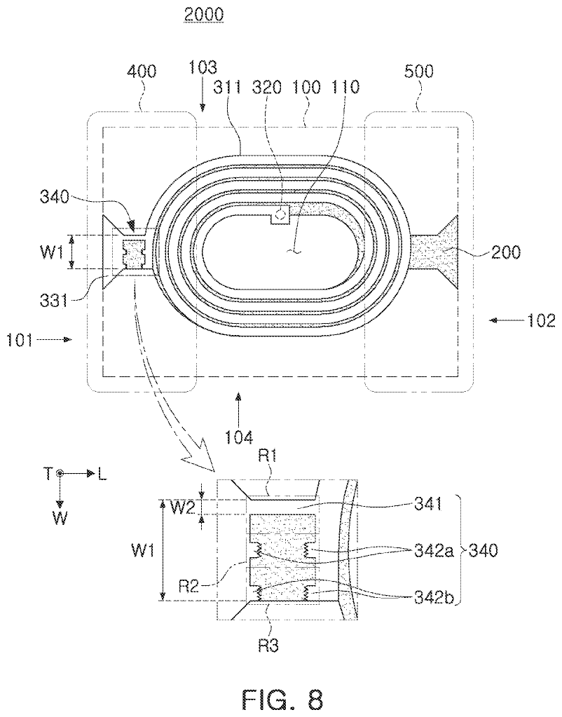

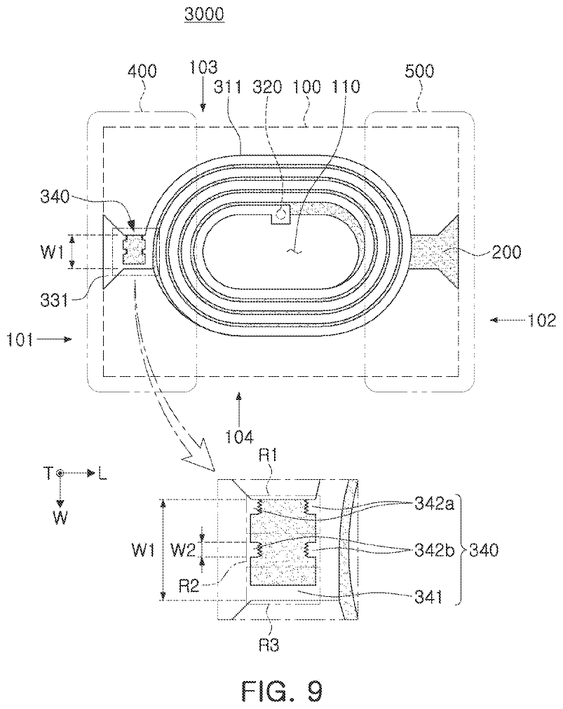

FIG. 8 is a view related to a second exemplary embodiment, in which the connection portion is disposed in a different manner, and corresponding to FIG. 3. FIG. 9 is a view related to a third exemplary embodiment, in which the connection portion is disposed in a different manner, and corresponding to FIG. 3.

Referring to FIGS. 8 and 9, the coil components 2000 and 3000 according to the second and third exemplary embodiments in the present disclosure are different from the coil component 1000 according to the first exemplary embodiment in the present disclosure in the arrangement relationship between the connection patterns 341 and 351 and the separation patterns 342a and 342b and 352a and 352b in the first and second connection portions 340 and 350. Thus, in describing the present exemplary embodiments, only the first and second connection portions 340 and 350, which are different from those in the first exemplary embodiment in the present disclosure, will be described.

Concerning the other configuration of the present exemplary embodiments, what has been described above for the first exemplary embodiment in the present disclosure may be identically applied thereto.

Referring to FIG. 8, in the coil component 2000 according to the second exemplary embodiment, the first connection pattern 341 may be disposed in the first region R1, and the separation patterns 342a and 342b may be formed in the second and third regions R2 and R3. In this case, since the end portion of the outermost turn of the first coil pattern 311 except a region where the first connection pattern 341 is branched therefrom forms an invalid turn, the coil component 2000 according to the second exemplary embodiment may have an effect as if a length of a coil becomes shorter than that in the coil component 1000 according to the first exemplary embodiment.

Accordingly, the coil component 2000 according to the second exemplary embodiment may have a smaller Rdc value than the coil component 1000 according to the first exemplary embodiment. Therefore, as a result of the above-described electrical inspection, when the measured Rdc value is above the target range, the first connection pattern 341 may be disposed in the first region R1, and the separation patterns 342a and 342b may be formed in the second and third regions R2 and R3 as in the present exemplary embodiment.

Meanwhile, the same may be applied to the second connection portion 350 independently. In a case where the smallest Rdc value is a target value, the second connection pattern 351 may be disposed in the fourth region R4, and the separation patterns 352a and 352b may be formed in the fifth and sixth regions R5 and R6, so that the second connection portion 350 also has a structure in which a length of a valid coil is smallest.

Referring to FIG. 9, in the coil component 3000 according to the third exemplary embodiment, the first connection pattern 341 may be disposed in the third region R3, and the separation patterns 342a and 342b may be formed in the first and second regions R1 and R2. In this case, since the first connection pattern 341 is disposed at the very end of the end portion of the outermost turn of the first coil pattern 311, the coil component 3000 according to the third exemplary embodiment may not form an invalid turn, unlike the coil component 1000 or 2000 according to the first or second exemplary embodiments. That is, the coil component 3000 according to the third exemplary embodiment may have an effect as if a length of a coil becomes shorter than that in the coil component 1000 according to the first exemplary embodiment.

Accordingly, the coil component 3000 according to the third exemplary embodiment may have a larger Rdc value than the coil component 1000 according to the first exemplary embodiment. Therefore, as a result of the above-described electrical inspection, when the measured Rdc value is below the target range, the first connection pattern 341 may be disposed in the third region R3, and the separation patterns 342a and 342b may be formed in the first and second regions R1 and R2 as in the present exemplary embodiment.

Meanwhile, the same may be applied to the second connection portion 350 independently. In a case where the largest Rdc value is a target value, the second connection pattern 351 may be disposed in the sixth region R6, and the separation patterns 352a and 352b may be formed in the fourth and fifth regions R4 and R5, so that the second connection portion 350 also has a structure in which a length of a valid coil is largest.

### Fourth Exemplary Embodiment

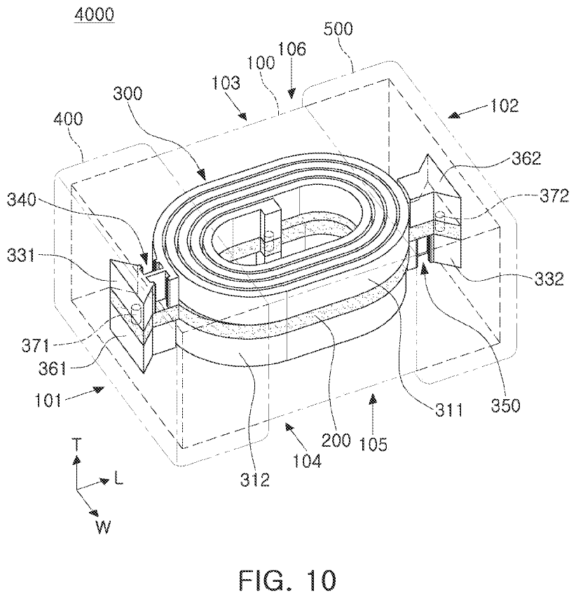

FIG. 10 is a schematic perspective view illustrating a coil component according to a fourth exemplary embodiment in the present disclosure.

Referring to FIG. 10, the coil component 4000 according to the fourth exemplary embodiment in the present disclosure is different from the coil component 1000 according to the first exemplary embodiment in the present disclosure in that first and second sub lead-out portions 361 and 362 and first and second sub vias 371 and 372 are further included. Thus, in describing the present exemplary embodiment, only the first and second sub lead-out portions 361 and 362 and the first and second sub vias 371 and 372, which are different from those in the first exemplary embodiment in the present disclosure, will be described. Concerning the other configuration of the present exemplary embodiment, what has been described above for the first exemplary embodiment in the present disclosure may be identically applied thereto.

The first and second sub lead-out portions 361 and 362 may be configured to enhance the fixing strength of the external electrodes 400 and 500 or to prevent warpage caused when upper and lower sides of the substrate 200 are asymmetric.

Referring to FIG. 10, the first and second sub lead-out portions 361 and 362 may be disposed to correspond to the first and second lead-out portions 331 and 332, respectively, with the substrate 200 interposed therebetween.

Specifically, the first sub lead-out portion 361 may be disposed on the second surface of the substrate 200 to be connected to the first external electrode 400, while being spaced apart from each of the first lead-out portion 331 and the second coil pattern 312. The second sub lead-out portion 362 may be disposed on the first surface of the substrate 200 to be connected to the second external electrode 500, while being spaced apart from each of the second lead-out portion 332 and the first coil pattern 311.

The first and second sub vias 371 and 372 may penetrate through the substrate 200 to connect the lead-out portions 331 and 332 and the sub lead-out portions 361 and 362 to each other, so that the sub lead-out portions 361 and 362 also function electrically. When the first and second sub vias 371 and 372 are disposed, surfaces of the sub lead-out portions 361 and 362 and the external electrodes 400 and 500 contacting each other may be electrically connected to each other, thereby reducing an overall Rdc characteristic.

Referring to FIG. 10, the first sub via 371 may penetrate through the substrate 200 to connect the first lead-out portion 331 and the first sub lead-out portion 361, and the second sub via 372 may penetrate through the substrate 200 to connect the second lead-out portion 332 and the second sub lead-out portion 362.

Meanwhile, both the first and second sub vias 371 and 372 may be omitted, or only one of the first and second sub vias 371 and 372 may be omitted.

At least one of the first and second sub lead-out portions 361 and 362 and the first and second sub vias 371 and 372 may include at least one conductive layer.

For example, when the first sub lead-out portion 361 and the first sub via 371 are formed on the second surface of the substrate 200 by plating, each of the first sub lead-out portion 361 and the first sub via 371 may include a seed layer and an electrolytic plating layer. Here, the electrolytic plating layer may have a single-layer structure or have a multi-layer structure. The electrolytic plating layer having the multi-layer structure may be formed in a conformal film structure in which one electrolytic plating layer is formed along a surface of another electrolytic plating layer, or may be formed by stacking one electrolytic plating layer on only one surface of another electrolytic plating layer. The seed layer may be formed by an electroless plating method, a vapor deposition method such as sputtering, or the like. The seed layers of the first sub lead-out portion 361 and the first sub via 371 may be integrally formed, such that no boundaries are formed therebetween, but are not limited thereto. The electrolytic plating layers of the first sub lead-out portion 361 and the first sub via 371 may be integrally formed, such that no boundaries are formed therebetween, but are not limited thereto.

Each of the first sub lead-out portion 361 and the first sub via 371 may be formed of a conductive material such as copper (Cu), aluminum (Al), silver (Ag), tin (Sn), gold (Au), nickel (Ni), lead (Pb), titanium (Ti), chromium (Cr), or an alloy thereof, but is not limited thereto.

As set forth above, according to the exemplary embodiments in the present disclosure, it is possible to provide a coil component having an Rdc characteristics that is finely adjusted by removing some of the plurality of conductors constituting the connection portions after the copper plating process to change a current path.

While exemplary embodiments have been shown and described above, it will be apparent to those skilled in the art that modifications and variations could be made without departing from the scope of the present invention as defined by the appended claims.

What is claimed is:

1. A coil component comprising:
a body;
a substrate disposed in the body, and having a first surface and a second surface facing each other;
a coil unit including first and second coil patterns disposed on the first surface and the second surface of the substrate, respectively, first and second lead-out portions extending to surfaces of the body, a first connection portion disposed between the first coil pattern and the first lead-out portion, and a second connection portion disposed between the second coil pattern and the second lead-out portion; and
first and second external electrodes disposed on the body and connected to the first and second lead-out portions, respectively,
wherein each of the first and second connection portions includes a connection pattern and at least one separation pattern, wherein the connection pattern has a smaller line width than a respective one of the first and second lead-out portions.

2. The coil component of claim 1, wherein the connection pattern is formed in a strip shape along a direction in which the surfaces of the body face each other.

3. The coil component of claim 1, wherein a ratio W2/W1 of the line width W2 of the connection pattern to an innermost line width W1 of a respective one of the first and second lead-out portions is 0.1 or more and 0.3 or less.

4. The coil component of claim 2, wherein a ratio W2/W1 of the line width W2 of the connection pattern to an innermost line width W1 of a respective one of the first and second lead-out portions is 0.1 or more and 0.3 or less.

5. The coil component of claim 1, wherein the first connection portion includes a first connection pattern branched from an end portion of an outermost turn of the first coil pattern to be connected to the first lead-out portion, and the second connection portion includes a second connection pattern branched from an end portion of an outermost turn of the second coil pattern to be connected to the second lead-out portion.

6. The coil component of claim 3, wherein the first connection portion includes a first connection pattern branched from an end portion of an outermost turn of the first coil pattern to be connected to the first lead-out portion, and the second connection portion includes a second connection pattern branched from an end portion of an outermost turn of the second coil pattern to be connected to the second lead-out portion.

7. The coil component of claim 5, wherein the first connection portion has first to third regions sequentially arranged in a direction in which the outermost turn of the first coil pattern is wound from an inner side to an outer side thereof, and the first connection pattern is disposed in any one of the first to third regions,
the second connection portion has fourth to sixth regions sequentially arranged in a direction in which the outermost turn of the second coil pattern is wound from an inner side to an outer side thereof, and the second connection pattern is disposed in any one of the fourth to sixth regions, and
the at least one separation pattern of the first connection portion is disposed in remaining regions of the first to third regions other than a region in which the first connection pattern is disposed, and the at least one separation pattern of the second connection portion is disposed in remaining regions of the fourth to sixth regions other than a region in which the second connection pattern is disposed.

8. The coil component of claim 6, wherein the first connection portion has first to third regions sequentially arranged in a direction in which the outermost turn of the first coil pattern is wound from an inner side to an outer side thereof, and the first connection pattern is disposed in any one of the first to third regions,
the second connection portion has fourth to sixth regions sequentially arranged in a direction in which the outermost turn of the second coil pattern is wound from an inner side to an outer side thereof, and the second connection pattern is disposed in any one of the fourth to sixth regions, and
the at least one separation pattern of the first connection portion is disposed in remaining regions of the first to third regions other than a region in which the first connection pattern is disposed, and the at least one separation pattern of the second connection portion is disposed in remaining regions of the fourth to sixth regions other than a region in which the second connection pattern is disposed.

9. The coil component of claim 1, wherein the at least one separation pattern includes a pair of cut-out surfaces facing each other and having a different surface roughness from other surfaces of the at least one separation pattern.

10. The coil component of claim 7, wherein the at least one separation pattern includes a pair of cut-out surfaces facing each other and having a different surface roughness from other surfaces of the at least one separation pattern.

11. The coil component of claim 9, wherein the pair of cut-out surfaces of the at least one separation pattern have a smaller surface roughness than the other surfaces of the at least one separation pattern.

12. The coil component of claim 9, wherein the pair of cut-out surfaces of the at least one separation pattern have a larger surface roughness than the other surfaces of the at least one separation pattern.

13. The coil component of claim 1, wherein the first and second lead-out portions have a cross-sectional area that gradually decreases in an inward direction from the surfaces of the body.

14. The coil component of claim 1, wherein the coil unit further includes a via penetrating through the substrate to connect the first and second coil patterns to each other.

15. The coil component of claim 1, wherein the coil unit further includes:
a first sub lead-out portion disposed on the second surface of the substrate to be connected to the first external electrode, while being spaced apart from the second coil pattern; and
a second sub lead-out portion disposed on the first surface of the substrate to be connected to the second external electrode, while being spaced apart from the first coil pattern.

16. The coil component of claim 15, wherein the coil unit further includes:
a first sub via penetrating through the substrate to connect the first lead-out portion and the first sub lead-out portion to each other; and
a second sub via penetrating through the substrate to connect the second lead-out portion and the second sub lead-out portion to each other.

17. A coil component comprising:
a body;
a substrate disposed in the body;
a coil unit including a coil pattern disposed on the substrate, a lead-out portion, and a connection portion disposed between the coil pattern and the lead-out portion; and
an external electrode disposed on the body and connected to the lead-out portion,
wherein the connection portion includes a connection pattern connecting an end portion of the coil pattern to the lead-out portion and at least one separation pattern spaced apart from the connection pattern, and
wherein the at least one separation pattern includes at least one protrusion that protrudes from an inner surface of the lead-out portion and/or an outer surface of the end portion of the coil pattern.

18. The coil component of claim 17, wherein the connection pattern has a smaller line width than the lead-out portion.

19. The coil component of claim 17, wherein the at least one separation pattern includes two separation patterns, and
the connection pattern is disposed between the two separation patterns.

20. The coil component of claim 17, wherein the at least one separation pattern includes two separation patterns, and
one of the two separation patterns is disposed between the connection pattern and a remaining one of the two separation patterns.
